(19) United States
(12) Patent Application Publication
(10) Pub. No.: US 2001/0038231 A1
(43) Pub. Date: Nov. 8, 2001

(54) Impact absorbing structure of vehicle

(76) Inventors: Yorito Takemoto, Okazaki-Shi (JP); Kunio Takaoka, Okazaki-Shi (JP); Toshiaki Sakurai, Fukushima (JP); Hiroyuki Nagura, Anjo-Shi (JP); Eiichi Kobayashi, Okazaki-Shi (JP); Masataka Miura, Okazaki-Shi (JP)

Correspondence Address: ROSSI & ASSOCIATES, P.O. Box 826, Ashburn, VA, 20146-0826, US

(21) Appl. No.: 09/790,319

(22) Filed: Feb. 22, 2001

(30) Foreign Application Priority Data
Feb. 22, 2000 (JP) JP 2000-044555

(51) Int. Cl. B60N 2/00

(52) U.S. Cl. 296/189

(57) ABSTRACT

A pair of cylindrical impact absorbing members, which is unintegrated with side members and is formed to have a substantially equilateral octagonal sectional form, is fixed on the side members in such a manner as to extend forward from the side members. Since the impact absorbing members are unintegrated with the side members, the impact absorbing members can be formed of optimum material with an optimum board thickness and can be formed to have an ideal sectional form by an optimum forming process under no restriction from a manufacturing method and the like for the side member.

### BACKGROUND OF THE INVENTION

1. Field of the Invention

The present invention relates to an impact absorbing structure of a vehicle, which is provided at a front part of a side member to absorb impact energy when the vehicle crashes.

2. Description of Related Art

In general, an impact absorbing member is provided at a front end of a front side member of a vehicle. When the vehicle crashes, the impact absorbing member is positively collapsed to prevent the spread of impact energy into the front side member in order to reduce damage. For example, Japanese Patent Provisional Publication No. 9-86438 discloses such an impact absorbing structure of a vehicle. In this impact absorbing structure, an impact absorbing member is integrated with a front end of a front side member. Normally, the sectional form of the impact absorbing member has a great influence on not only the collapsing state but also an impact absorbing effect when the vehicle crashes. Therefore, in order to achieve a desirable impact absorbing effect, it is very important to correctly form a target sectional form of the impact absorbing structure when the vehicle is designed. In the impact absorbing structure of the above-mentioned publication, however, the impact absorbing member is formed integrally with the front side member. Thus, the sectional form of the impact absorbing member is restricted by a manufacturing method for the front side member. This makes it impossible to achieve an ideal sectional form of the impact absorbing member.

### SUMMARY OF THE INVENTION

It is therefore an object of the present invention to provide an impact absorbing structure of a vehicle, which enables the formation of an ideal sectional form of a tubular impact absorbing member by providing a separate (unintegrated) impact absorbing member that is coupled to a front side member in order to surely achieve a desirable impact absorbing effect when a vehicle crashes.

The above object can be accomplished by providing an impact absorbing structure of a vehicle, comprising: a side member constructed by splicing a plurality of panels, the connection of the plurality of panels forming closed sections of the side member along a longitudinal side of the vehicle; an impact absorbing member unintegrated with the side member, the impact absorbing member being composed of a tubular single component; and wherein the impact absorbing member is fixed to the side member in such a manner as to extend forward from the side member.

As stated above, the impact absorbing member is unintegrated with the side member whose closed section is formed by splicing the plurality of panels, and the impact absorbing member is composed of a tubular single component. Therefore, the impact absorbing member can be formed of optimum material with an optimum board thickness under no restriction from the material, the board thickness, the forming process, etc. of the side member, and every portion of the impact absorbing member composed of the single component has an equal buckling strength. This achieves an ideal impact absorbing effect.

The above object can also be accomplished by providing an impact absorbing structure of a vehicle, comprising: a pair of side members constructed by splicing a plurality of panels, the connection of the plurality of panels forming closed section of the side members along a longitudinal side of the vehicle; a pair of impact absorbing members unintegrated with the side members, each of the impact absorbing members being composed of a tubular single component; and wherein the pair of side members is disposed symmetrically at right and left sides at a certain interval along a width of the vehicle, the pair of impact absorbing members are fixed to the side members in such a manner as to extend forward from the side members, and the impact absorbing members disposed symmetrically are connected to each other by a connecting member. As stated above, the impact absorbing member is unintegrated with the side member whose closed section is formed by splicing the plurality of panels, and the impact absorbing member is composed of a tubular single component. Therefore, the impact absorbing member can be formed of optimum material with an optimum board thickness under no restriction from the material, the board thickness, the forming process, etc. of the side member, and every portion of the impact absorbing member composed of the single component has an equal buckling strength. This achieves an ideal impact absorbing effect. Moreover, the connecting member is disposed between the right and left impact absorbing members to connect the right and left impact absorbing members. Therefore, if either one of the right and left impact absorbing members is impacted as is the case with a so-called offset crash, the impact energy is transmitted from the impacted impact absorbing member to the other through the connecting member. This further improves the impact absorbing effect.

The above object can also be accomplished by providing an impact absorbing structure of a vehicle, comprising: a side member extending along a longitudinal side of the vehicle; a tubular impact absorbing member being constructed by connecting a pair of separate bodies continuously, the impact absorbing members being unintegrated with the side member; and wherein the impact absorbing member is fixed to the side member in such a manner as to extend forward from the side member.

As stated above, the impact absorbing member is unintegrated with the side member, and the impact absorbing member is composed of a tubular single component. Therefore, the impact absorbing member can be manufactured with optimum material with an optimum board thickness under no restriction from the material, the board thickness, the forming process, etc. of the side member. Moreover, the pair of separate bodies can be formed by a bending process to form the impact absorbing member. This is advantageous because the bending process can be executed with a small equipment investment. In addition, since the pair of separate bodies are spliced together continuously, the impact absorbing member has an equal buckling strength at every portion part along the spliced area. This achieves an ideal impact absorbing effect.

The above object can also be accomplished by providing an impact absorbing structure of a vehicle, comprising: a pair of side members extending along a longitudinal side of the vehicle; a pair of tubular impact absorbing member, each one of which is constructed by connecting a pair of separate bodies continuously, the impact absorbing members being unintegrated with the side members; and wherein the pair of side members is disposed symmetrically at right and left sides at a certain interval along a width of the vehicle, the pair of impact absorbing members are fixed to the side members in such a manner as to extend forward from the side members, and the impact absorbing members disposed symmetrically are connected by a connecting member.

As stated above, the impact absorbing member is unintegrated with the side member, and the impact absorbing member is composed of a tubular single component. Therefore, the impact absorbing member can be manufactured with optimum material with an optimum board thickness under no restriction from the material, the board thickness, the forming process, etc. of the side member. Moreover, the pair of separate bodies can be formed by a bending process to form the impact absorbing member. This is advantageous because the bending process can be executed with a small equipment investment. In addition, since the pair of separate bodies are spliced together continuously, the impact absorbing member has an equal buckling strength at every portion part along the spliced area. This achieves an ideal impact absorbing effect. Also, the connecting member is disposed between the right and left impact absorbing members to connect the right and left impact absorbing members. Therefore, if either one of the right and left impact absorbing members is impacted as is the case with a so-called offset crash, the impact energy is transmitted from the impacted impact absorbing member to the other through the connecting member. This further improves the impact absorbing effect.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is an exploded perspective view showing an impact absorbing structure of a vehicle according to the first embodiment;

FIG. 2 is an exploded perspective view showing a front side member at the left side;

FIG. 3 is a perspective view showing the assembled state of an impact absorbing member;

FIG. 4 is a sectional view along line IV-IV of FIG. 3, showing the integrated state of a front side member and an impact absorbing member;

FIG. 5 is a sectional view showing the material of the impact absorbing member;

FIG. 6 is an exploded perspective view showing an impact absorbing structure of a vehicle according to the second embodiment; and

FIG. 7 is a sectional view along line VII-VII of FIG. 6, showing the integrated state of a front side member and an impact absorbing member.

### DETAILED DESCRIPTION OF THE PREFERRED EMBODIMENTS

### First Embodiment

There will now be described an impact absorbing structure of a vehicle according to the first embodiment of the present invention.

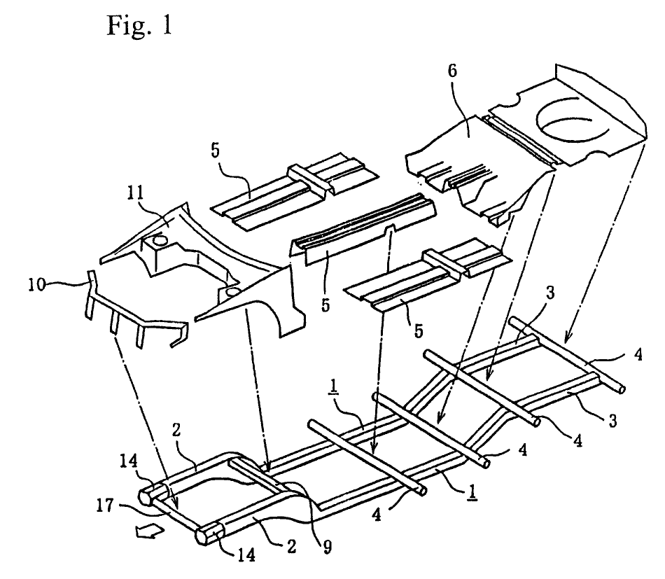

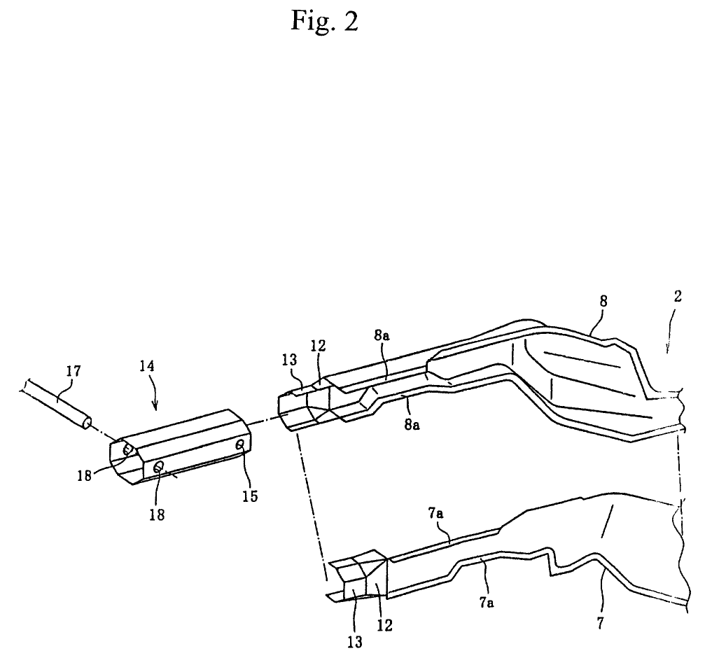

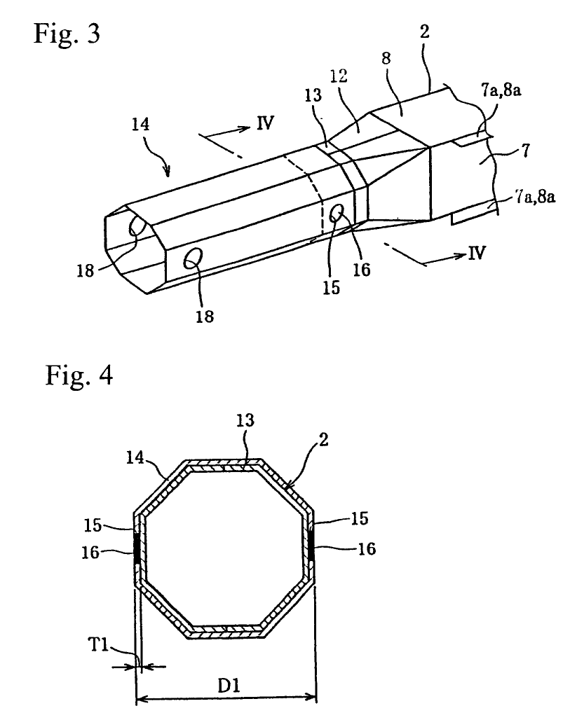

FIG. 1 is an exploded perspective view showing the impact absorbing structure of the vehicle according to the first embodiment of the present invention, FIG. 2 is an exploded view showing a front side member at the left side, and FIG. 3 is a perspective view showing the assembled state of the impact absorbing member. The left side in FIG. 1 corresponds to a front part of the vehicle. Although not shown in the drawing, a front side member at the right side is provided symmetrically with the left one in FIG. 2.

As shown in FIG. 1, a pair of side members 1 is disposed along the longitudinal side of the vehicle. Each side member 1 is comprised of a front side member 2 and a rear side member 3. Both rear side members 3 have a concave sectional form, which opens upward, and they are corrugated in accordance with the form of a vehicle floor or the like. Both rear side members 3 are integrated with each another through four cross pipes 4, which are disposed along the width of the vehicle and have circular sectional forms. A front floor pan 5 and a rear floor pan 6, each of which is divided into three parts, are provided on the rear side members 3. The rear side members 3 are fixed by welding the lower side of the floor pans 5, 6 to thereby form a closed sectional form, which extends in the interior of the vehicle along the longitudinal side.

Each front side member 2 is comprised of an outer panel 7 and an inner panel 8, which are disposed along the width of the vehicle. The outer panel 7 and the inner panel 8 are molded by pressing. Flange parts 7a, 7a and flange parts 8a, 8a, which are formed at the periphery of the outer panel 7 and the inner panel 8, are spot-welded together to thereby form a closed section, which extends in the interior of the vehicle along the longitudinal side. The most suitable way to form the large front side member 2 is to weld the outer panel 7 and the inner panel 8. The front side members 2 are welded continuously with the rear side members 3, and the front side members 2 are integrated through a cross member 9 with a square sectional form, which is disposed along the width of the vehicle. A radiator support 10 and a dash panel unit 11 are welded and fixed on both front side members 2. An engine room is formed by the radiator support 10 and the dash panel unit

As shown in FIGS. 2 and 3, each front side member has a substantially square sectional form, and a connecting part 13 having an equilateral octagonal sectional form is formed at a front end of each front side member via a gradually-changing part 12. The rear part of the gradually-changing part 12 has a square sectional form, and the front part thereof has a substantially equilateral octagonal sectional form. Accordingly, the sectional form changes gradually from the front side member 2 to the connecting part 13. A tubular impact absorbing member 14 with a length of about 400mm, which is composed of a single component, is mounted on the connecting part 13 of each front side member 2 from forward.

FIG. 4 is a sectional view taken along line IV-IV of FIG. 3, showing the integrated state of the front side member and the impact absorbing member. As shown in FIG. 4, welding holes 15 are formed at both sides of the rear part of the impact absorbing member 14. A plug welding is executed for the outside face of the connecting part 13 through the welding holes 15. This results in the formation of welded parts 16, which fix the impact absorbing member 15 to the front end of the front side member 2. A cross pipe 17 as the same connecting member as the above-mentioned cross pipe 14 is disposed between the right and left impact absorbing members 14. The right and left ends of the cross pipe 17 are inserted into engagement holes 18 formed at both sides of the front part of the impact absorbing member 14 and are fixed by welding. This connects the right and left impact absorbing members 14. The above-mentioned radiator support 10 is also welded to the cross pipe 17, which functions as a structural member for connecting the right and left impact absorbing members 14 and supporting the radiator.

There will now be described the procedure for manufacturing the impact absorbing members 14 constructed in the above-mentioned manner and the procedure for assembling the impact absorbing members 14 and the front side members 2.

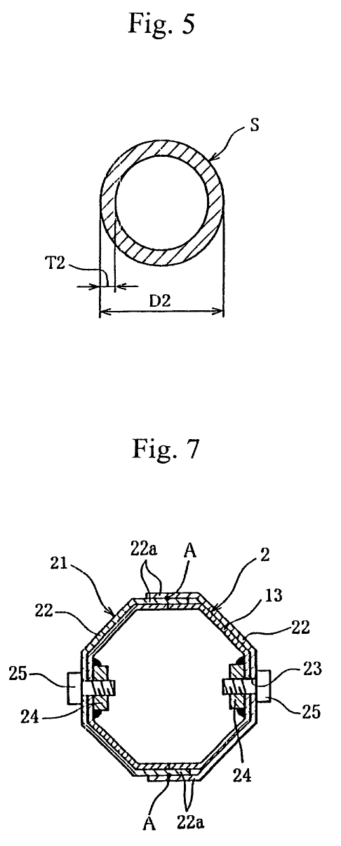

The impact absorbing member 14 is integrally formed by a hydroforming process. FIG. 5 is a sectional view showing the material S of the impact absorbing member 14. For example, the material S with an outer diameter D2 of 42 mm and a thickness T2 of 1.8 mm is used to form the impact absorbing member 14 with an outer diameter D1 of 100 mm and a thickness T1 of 1.2 mm. The material S is then placed in a forming die which corresponds to the sectional form of the impact absorbing member 14. If a water pressure is applied to the inside of the material S, the material S is extended to be fitted in the forming die and the thickness of the material S is decreased. Consequently, the material S has substantially a desired equilateral octagonal sectional form in FIG. 4.

The impact absorbing member 14 manufactured in the above-mentioned procedure is mounted on the connecting part 13 of the front side member 2 and is fixed by the plug-welding process. Both ends of the cross pipes 17 are then inserted into the engagement holes 18 of the right and left impact absorbing members 14 and are fixed by welding. That completes the assembly of the impact absorbing members 14 and the front side members 2.

A work hardening in the formation results in an improvement in the mechanical property of the material S. Thus, the material S, which is necessary for achieving the mechanical property required for the impact absorbing member 14 to absorb the impact energy, can be made of material having a low mechanical property with the improvement being taken into consideration. More specifically, the impact absorbing effect during the crash of the vehicle is generally represented by a buckling strength, and according to the present embodiment, a more general breaking strength correlated to the buckling strength is used as a reference to choose the material S. As a result of a test conducted by the applicant of the present invention, it was found that if the impact absorbing member 14 was extended by extending the diameter of the material S and reducing the thickness thereof as stated above, the breaking strength of the impact absorbing member 14 was improved by about 30% after the extension compared with the manufacture before the extension. More specifically, the material S with a relatively low mechanical property, i.e., the cheap material S can be used to obtain the impact absorbing member 14 with a desired impact absorbing power. Particularly according to the first embodiment, the material S is extended by the hydroforming process in order to form the impact absorbing member 14. This improves the mechanical property of the material S.

When the vehicle crashes forward, the impact absorbing member 14 is collapsed due to the buckling and then absorbs the impact energy. This prevents the spread of the impact energy into the front side member 2 and reduces the damage.

To achieve a high impact absorbing power, the impact absorbing member 14 preferably has an octagonal sectional form. When the vehicle crashes, eight comers of the impact absorbing member 14 are mainly collapsed against the buckling strength to absorb the impact energy. The most preferable sectional form of the impact absorbing member 14 is a substantially equilateral octagonal shape. Although the impact absorbing member 14 has the substantially equilateral octagonal sectional form according to the first embodiment, the impact absorbing member 14 may have another sectional form such as a hexagonal shape and a square shape on condition that the equal impact absorbing power could be achieved. In any case, it is very important to correctly form a desired sectional form (e.g., a polygonal sectional form with clearly-formed edges). According to the present embodiment, the above-mentioned hydroforming process correctly forms the desired sectional form of the impact absorbing member 14. Moreover, the tubular impact absorbing member 14 has the substantially equilateral polygonal sectional form, i.e., the equilateral polygonal sectional form according to the present embodiment, the impact absorbing member 14 can buckle without bending halfway. This improves the impact absorbing effect.

As stated above, in the impact absorbing structure of the vehicle according to the present embodiment, the impact absorbing member 14 is unintegrated with the front side member 2. Therefore, the impact absorbing member 14 can be formed of optimum material with an optimum board thickness under no restriction from the material, the board thickness, etc. of the front side member 2. Moreover, the impact absorbing member 14 is composed of a single component to achieve an ideal impact absorbing effect regardless of a forming process (the press-molded parts are spliced together by welding as stated previously) that is the most suitable for the manufacture of the front side member 2. Therefore, the manufacturing process for the impact absorbing member is never restricted to the manufacturing process for the front side member due to the integration of the impact absorbing member and the front side member as is the case with the technique disclosed in e.g., Japanese Patent Provisional Publication No. 9-86438.

Thus, the hydroforming process forms the ideal sectional form of the impact absorbing member 14, and surely achieves the desired impact absorbing effect. The forming process for the energy absorbing process should not be restricted to the hydroforming process in the above description. For example, a known bulging process may also be used. Particularly if the impact absorbing member 14 is formed by the hydroforming process or the bulging process, the impact absorbing member 14 can be formed of a single component without combining a plurality of components. This realizes the uniform buckling strength at every portion of the impact absorbing member 14, and achieves the ideal impact absorbing effect.

According to a forming process such as the hydroforming process and the bulging process in which the material S is entirely machined (expanded) by applying the pressure of the fluid to the inner wall of the tubular material S disposed in the forming die to extend the material S, the cheap material S with a low mechanical property can be used to manufacture the impact absorbing member 14 having the desired impact absorbing power. This reduces the manufacturing cost.

Moreover, the impact absorbing member 14 has the substantially equilateral octagonal sectional form, which achieves a higher impact absorbing effect than other sectional forms. According to the first embodiment described above, the impact absorbing member 14 can be formed to have the substantially equilateral octagonal sectional form under no restriction from the material, the shape, the forming process, etc. of the front side member 2.

Furthermore, the front side member 2 is unintegrated with the impact absorbing member 14, only the changes in the length, the board thickness, etc. of the impact absorbing member 14 make it possible to flexibly cope with the differences in the overall length of various car models in the case where the same chassis is applied to them.

In addition, the cross pipe 17 is disposed between the right and left impact absorbing members 14 to connect the right and left impact absorbing members 14. Therefore, if either one of the right and left impact absorbing members is impacted as is the case with a so-called offset crash, the impact energy is transmitted from the impacted impact absorbing member 14 to the other through the cross pipe 17. This further improves the impact absorbing effect.

### Second Embodiment

There will now be described the second embodiment of the impact absorbing structure of the vehicle according to the present invention.

The impact absorbing structure of the vehicle according to the second embodiment is different from the first embodiment in the structure of an impact absorbing member 21 and the assembled state of the impact absorbing member 21 and the front side member 2. Otherwise, the impact absorbing structure of the second embodiment is constructed in the same manner as that of the first embodiment. Thus, the same parts will not be described and the different parts will only be described.

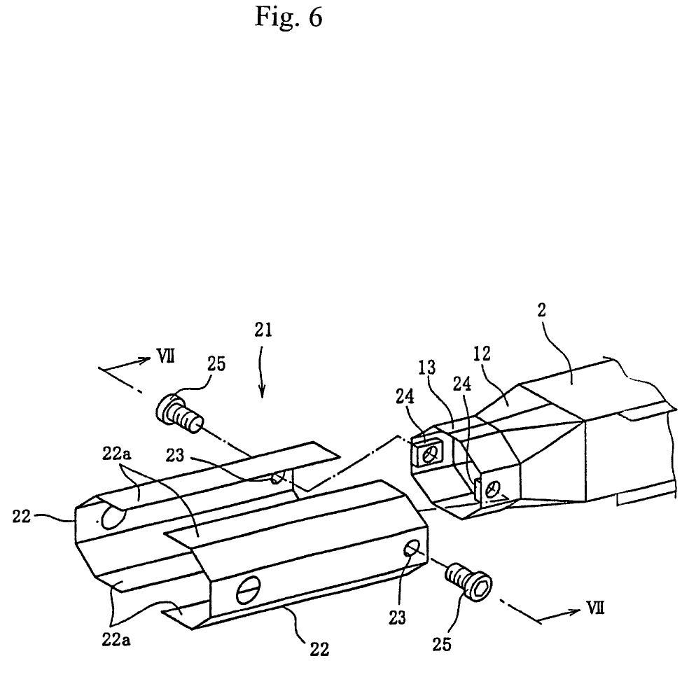

FIG. 6 is an exploded perspective view showing an impact absorbing structure of the vehicle according to the second embodiment; and FIG. 7 is a sectional view along line VII-VII of FIG. 6, showing the integrated state of the front side member and the impact absorbing member. As shown in FIGS. 6 and 7, the impact absorbing member 21 of the present embodiment is composed of a pair of right and left separate bodies 22 composed of the same members which are substantially semicylindrical. Each separate body 22 comprises five sides of a substantially equilateral octagon, and the sectional forms of two separate bodies 22 face each other. Facing two sides 22a of the substantial equilateral octagon are overlapped, and the overlapped two sides 22a are spliced together to construct the tubular impact absorbing member 21 having the substantially equilateral octagonal sectional form as is the case with the first embodiment. Bolt holes 23 are formed at both sides of the rear part of the impact absorbing member 21, and nut parts 24 corresponding to the bolt holes 23 are welded at the connecting part 13 of the front side member 2. The impact absorbing member 21 is mounted on the connecting part 13, and is fixed by bolts through the nut parts 24.

The separate bodies 22 are separately formed by bending, and they are then spliced together by laser welding, gas welding, etc. over the longitudinal side with the facing two sides 22a being overlapped. More specifically, the impact absorbing member 221 of the second embodiment is formed of a single component regardless of the front side member 2 as is the case with the first embodiment. Therefore, the impact absorbing member 21 can be formed of optimum material with an optimum board thickness under no restriction from the material, the board thickness, etc. of the front side member 2. Moreover, the impact absorbing member 21 can be formed to have an ideal sectional form by bending under no restriction from the manufacturing process for the front side member 2. This surely achieves the desired impact absorbing effect.

As is well known, the bending process for forming the separate bodies 22 and the laser welding process and the gas welding process for splicing the formed separate bodies 22 require by far the lower equipment investment than the hydroforming process that is used for forming the impact absorbing member 14 of the first embodiment. It is therefore possible to further reduce the manufacturing cost compared with the first embodiment. According to the second embodiment, the separate bodies 22 are spliced together in the longitudinal direction with the two sides 22a being overlapped, and therefore, the buckling strength is equal at every part along the spliced area of the impact absorbing member 21. This achieves the ideal impact absorbing effect. In this case, the substantially semicylindrical same members are used as the right and left separate bodies. Thus, the facing sides of the impact absorbing member 21 can be the sides 22a where the separate bodies 22 are overlapped. Accordingly, the facing sides of the impact absorbing member 21 have the equal buckling strength, and this prevents the impact absorbing member 21 from bending in the middle of buckling. Particularly according to the second embodiment, the pair of right and left separate bodies 22 having the facing sectional forms comprised of five sides of the substantial equilateral octagon is used, and the two sides 22a as the facing two sides of the substantial equilateral octagon are overlapped and welded continuously so that the impact absorbing member 21 can be tubular and have the substantial octagonal sectional form. Thus, the impact absorbing member 21 has the ideal sectional form for absorbing the impact energy, and the facing sides have the equal buckling strength. Since the front side member 2 is unintegrated with the impact absorbing member 21, the spliced part of the separate bodies 22 can be determined regardless of the spliced part of the outer panel 7 and the inner panel 8 in the front side member 2. The facing sides of the impact absorbing member 21 can easily have the equal buckling strength.

According to the second embodiment, the pair of right and left separate bodies 22 are spliced together by welding, but the present invention should not be restricted to this. For example, the separate bodies 22 can be adhered to one another by an adhesive agent.

That completes the description of the embodiments, but there is no intention to limit the invention to the above embodiments. For example, the invention is applied to the impact absorbing structure of a passenger car, but the invention may also be applied to a wagon and a one box car.

According to the above embodiments, the impact absorbing members 14, 21 have the substantial equilateral octagonal sectional form. The sectional form, however, may be arbitrarily changed. For example, the sectional form may also be a hexagon and a square.

According to the first embodiment, the impact absorbing member 14 is fixed on the front side member 2 by plug welding, but the present invention should not be restricted to this fixing process on condition that a necessary mounting strength is achieved. For example, the fixing process of the first embodiment can be replaced with that of the second embodiment and vice versa.

It should be understood, however, that there is no intention to limit the invention to the specific forms disclosed, but on the contrary, the invention is to cover all modifications, alternate constructions and equivalents falling within the spirit and scope of the invention as expressed in the appended claims.

1. An impact absorbing structure of a vehicle, comprising:
a side member constructed by splicing a plurality of panels, the connection of said plurality of panels forming closed sections of said side member located along a longitudinal side of said vehicle;
an impact absorbing member, said impact absorbing member being composed of a single tubular component; and
wherein said impact absorbing member is fixed to said side member in such a manner as to extend forward from said side member.

2. An impact absorbing structure of a vehicle according to claim 1, wherein:
said impact absorbing member is formed to have an octagonal sectional form.

3. An impact absorbing structure of a vehicle according to claim 1, wherein:
said side member includes a gradually-changing part comprising a sectional form that gradually changes, and a connecting part extending forward continuously from said gradually-changing part at a front end of said side member, wherein said connecting part comprises substantially the same sectional form as that of said impact absorbing, and said impact absorbing member is coupled to said connecting part.

4. An impact absorbing structure of a vehicle according to claim 2, wherein:
welding holes are formed in said impact absorbing member, and said impact absorbing member and said connecting part are welded and fixed through said welding holes.

5. An impact absorbing structure of a vehicle according to claim 1, wherein:
said impact absorbing member is formed by applying pressure of a fluid to an inner wall of cylindrical material disposed in a forming die and extending said material to be fitted in said forming die.

6. An impact absorbing structure of a vehicle according to claim 1, wherein:
said impact absorbing member is formed by a hydroforming process or a bulging process.

7. An impact absorbing structure of a vehicle, comprising:
a pair of side members constructed by splicing a plurality of panels, the connection of said plurality of panels forming closed sections of said side members along a longitudinal side of said vehicle;
a pair of impact absorbing members, each of said impact absorbing members being composed of a single tubular component; and
wherein said side members are disposed symmetrically at right and left sides at a certain interval along a width of said vehicle, said pair of impact absorbing members are fixed to said side members in such a manner as to extend forward from said side members, and said impact absorbing members disposed symmetrically are connected to each other by a connecting member.

8. An impact absorbing structure of a vehicle according to claim 7, wherein:
said connecting member is composed of a pipe member, said connecting member being fittingly inserted into an engagement hole formed in said impact absorbing members.

9. An impact absorbing structure of a vehicle according to claim 8, wherein:
a radiator supporting member is fixed to said connecting member, an end of said connecting member being attached to said side members.

10. An impact absorbing structure of a vehicle, comprising:
a side member extending along a longitudinal side of said vehicle;
an impact absorbing member comprising a pair of connected bodies; and
wherein said impact absorbing member is fixed to said side member in such a manner as to extend forward from said side member.

11. An impact absorbing structure of a vehicle according to claim 10, wherein:
said bodies are formed by bending.

12. An impact absorbing structure of a vehicle according to claim 11, wherein:
said bodies are connected by a continuous weld.

13. An impact absorbing structure of a vehicle according to claim 12, wherein:
said bodies are composed of substantially similar members and are substantially semicylindrical.

14. An impact absorbing structure of a vehicle according to claim 13, wherein:
said impact absorbing member is formed to have an octagonal sectional form.

15. An impact absorbing structure of a vehicle according to claim 14, wherein:
a sectional form of each of said bodies has five sides of an octagon, and if said bodies are overlapped, two sides of said octagon are overlapped and spliced together continuously.

16. An impact absorbing structure of a vehicle according to claim 10, wherein:
said side member includes a gradually-changing part comprising a sectional form that gradually changes, and a connecting part extending forward continuously from said gradually-changing part at a front end of said side member, wherein said connecting part comprises substantially the same sectional form as that of said impact absorbing and said impact absorbing member is coupled to said connecting part

17. An impact absorbing structure of a vehicle, comprising:
a pair of side members;
a pair of tubular impact absorbing members, each one of which is constructed by connecting a pair of separate bodies together; and
wherein said side members are disposed symmetrically at right and left sides at a certain interval along a width of said vehicle, said pair of impact absorbing members are fixed to said side members in such a manner as to extend forward from said side members, and said impact absorbing members disposed symmetrically are connected by a connecting member.

18. An impact absorbing structure of a vehicle according to claim 17, wherein:
said connecting member is composed of a pipe member, said connecting member being fittingly inserted into an engagement hole formed in said impact absorbing members.

19. An impact absorbing structure of a vehicle according to claim 18, wherein:
a radiator supporting member is fixed to said connecting member, an end of said connecting member being attached to said side members.
